(19) United States
(12) Patent Application Publication
(10) Pub. No.: US 2026/0340308 A1
(43) Pub. Date: Oct. 29, 2026

(54) MANAGING OPTIMIZATION OF ARTIFICIAL INTELLIGENCE (AI) MODEL PROMPTS BASED ON DOWNSTREAM CONSUMER FEEDBACK

(71) Applicant: Dell Products L.P., Round Rock, TX (US)

(72) Inventors: OFIR EZRIELEV, Be'er Sheva (IL); HANNA YEHUDA, Acton, MA (US); ANNE-MARIE MCREYNOLDS, San Jose, CA (US)

(21) Appl. No.: 19/191,570

(22) Filed: Apr. 28, 2025

(51) Int. Cl. G06F 40/40; G06F 40/166; G06N 3/0475

(52) U.S. Cl. CPC G06F 40/40; G06F 40/166; G06N 3/0475

(57) ABSTRACT

Methods and systems for providing computer-implemented services using generative AI models are disclosed. To do so, an output may be generated by a generative artificial intelligence (AI) model based on a prompt. Feedback from a downstream consumer may be obtained based on the output, the feedback indicating a desired modification to a portion of the output. A prompt optimization process may be performed using at least the prompt and the feedback to obtain one or more modified prompts. The one or more modified prompts may be usable as ingest for the generative AI model to generate modified outputs that meet the desired modification and that meet stability criteria for maintaining integrity of other portions of the output. At least the one or more modified prompts may be provided to a downstream consumer as part of providing computer-implemented services to the downstream consumer.

### FIELD

Embodiments disclosed herein relate generally to providing computer-implemented services using generative artificial intelligence (AI) models. More particularly, embodiments disclosed herein relate to managing optimization of AI model prompts based on downstream consumer feedback.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a diagram illustrating a system in accordance with an embodiment.

FIGS. 2A-2D show flow diagrams illustrating data flows in accordance with an embodiment.

FIGS. 2E-2H show examples of data used to perform portions of prompt optimization processes in accordance with an embodiment.

FIGS. 3A-3D show flow diagrams illustrating a method for providing computer-implemented services using generative AI models in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for providing computer-implemented services using generative AI models. The generative AI models may include large language models (LLMs) that may generate outputs when provided with prompts. The outputs may be used, at least in part, to provide the computer-implemented services. For example, the outputs may be provided to a downstream consumer and the downstream consumer may use the outputs to make decisions.

However, the outputs may not meet expectations of the downstream consumer if the downstream consumer does not understand why an output was generated. For example, a downstream consumer (e.g., a client, a customer) may desire to use an output to manage a computer system. However, if the LLM does not operate as expected (e.g., due to data drift in training data and/or production data, due to bias in the training data and/or production data), the output may negatively impact the computer system. In addition, the computer system managed by the client may store private medical information, private financial information, and/or other data protected by various regulatory standards (e.g., General Data Protection Regulation (GDPR), Health Insurance Portability and Accountability Act (HIPAA)). The client may choose not to utilize the output generated by the LLM if the client is unable to determine whether the output generation process complies with one or more regulatory standards.

To increase a likelihood of outputs generated by generative AI models meeting expectations of downstream consumers, explainability information for outputs may be provided along with the outputs to downstream consumers. Explainability information may provide downstream consumers with insight into a generative AI model's decision-making processes and may allow the downstream consumer to make adjustments to the prompt to alter a particular portion of the output.

The explainability information may indicate relationships between portions of the prompt and portions of the output. The explainability information may be obtained by: (i) iteratively perturbating information content of the prompt to obtain perturbated prompts, (ii) generating, using the generative AI model and the perturbated prompts, perturbated outputs, (iii) comparing the perturbated outputs to identify the relationships between the portions of the prompt and the portions of the output.

However, the prompt may include a large number of information elements and, therefore, iteratively perturbating the prompt and testing each perturbated prompt may be costly (e.g., may consume an undesirable quantity of computational resources and/or time resources). Therefore, an optimization algorithm may be used to perform an output optimization process to reduce the number of iterations to the prompt and increase efficiency of generation of the explainability information for the downstream consumer.

For example, a downstream consumer may be provided with an output (e.g., via a graphical user interface (GUI)) based on a prompt. The downstream consumer may provide feedback based on the output, the feedback indicating a desired modification to a portion of the output. The desired modification may include: (i) removal of information content of the portion of the output, (ii) replacement of the information content of the portion of the output with other information content, and/or (iii) other modifications.

An output optimization process may be performed, based on the prompt and the feedback, to obtain one or more modified prompts. The one or more modified prompts may be usable as ingest by the generative AI model to obtain modified outputs that meet: (i) the desired modification to the portion of the output and (ii) stability criteria for maintaining integrity of other portions of the output.

Performing the output optimization process may include: (i) iteratively perturbating information content of the prompt to obtain perturbated prompts (e.g., as guided by an optimization algorithm), (ii) obtaining, using the perturbated prompts and the generative AI model, perturbated outputs, (iii) evaluating, using an objective function, the perturbated outputs to obtain success scores for the perturbated outputs (e.g., indicating an extent to which each perturbated output meets the desired modification and the stability criteria), and/or (iv) determining, using a success score threshold and the success scores, whether any of the success scores meet the success score threshold. If a subset of the success scores meets the success score threshold, a corresponding subset of the perturbated prompts (e.g., that were used to generate a subset of the perturbated outputs that correspond to the subset of the success scores) may be provided to the downstream consumer as part of providing computer-implemented services to the downstream consumer.

Thus, embodiments disclosed herein may provide an improved method for providing computer-implemented services using generative AI models. To provide the computer-implemented services as desired by downstream consumers, an optimization algorithm may be used to select one or more modifications to the prompt that are likely to meet expectations of the downstream consumer. Doing so may increase transparency of the output generation process while reducing a computational cost associated with generating explainability information for the outputs.

In an embodiment, a method for providing computer-implemented services using generative AI models is provided. The method may include: obtaining an output generated by a generative AI model of the generative AI models based on a prompt; obtaining, based on the output, feedback from a downstream consumer, the feedback indicating a desired modification to a portion of the output; performing, using at least the prompt and the feedback, a prompt optimization process to obtain one or more modified prompts that are usable as ingest for the generative AI model to generate modified outputs that meet: the desired modification, and stability criteria for maintaining integrity of other portions of the output; and providing at least the one or more modified prompts to a downstream consumer as part of providing computer-implemented services to the downstream consumer.

The desired modification may include at least one modification selected from a list of modifications consisting of: removal of information content of the portion of the output; and replacement of the information content of the portion of the output with other information content.

Performing the prompt optimization process may include: iteratively perturbating information content of the prompt to obtain perturbated prompts; obtaining, using the perturbated prompts and the generative AI model, perturbated outputs; evaluating, using an objective function, the perturbated outputs to obtain success scores for the perturbated outputs; making a determination, using a success score threshold and the success scores, regarding whether any of the success scores meet the success score threshold; in an instance of the determination in which a subset of the success scores meets the success score threshold: obtaining, using a subset of the perturbated outputs corresponding to the subset of the success scores, a subset of the perturbated prompts that were used to generate the subset of the perturbated outputs; and using the subset of the perturbated prompts as the one or more modified prompts.

Iteratively perturbating the information content of the prompt may include: obtaining information elements of the prompt; performing at least one action selected from a list of actions consisting of: removing a first information element of the information elements to obtain a first modified prompt; and replacing the first information element with a replacement information element to obtain the first modified prompt.

The objective function may assign the success scores to the perturbated outputs based on: (i) degrees to which the perturbated outputs fulfill the desired modification, and (ii) degrees to which the perturbated outputs meet the stability criteria.

The stability criteria may define at least a maximum acceptable difference between information elements of the output and information elements of a modified output of the modified outputs.

The prompt optimization process may be performed, at least in part, using an optimization algorithm to guide the iterative perturbating of the information content of the prompt to obtain the perturbated prompts.

The optimization algorithm may be a bacterial foraging optimization (BFO) algorithm.

The method may also include: prior to obtaining the feedback from the downstream consumer: obtaining a first graphical representation of the output, the first graphical representation including: nodes that correspond to information elements of the output, and edges that represent relationships between the nodes; and populating a graphical user interface (GUI) with the output and the first graphical representation, the GUI being accessible by the downstream consumer.

The method may also include: after populating the GUI with the output and the first graphical representation: obtaining, from the downstream consumer and via the GUI, preferences that indicate a portion of the output that is desired to be viewed; generating, based on the preferences, a second graphical representation of the output, the second graphical representation comprising a subset of the nodes that correspond to the portion of the output to focus an attention of the downstream consumer on the subset of the nodes; and populating the GUI with the second graphical representation.

The generative AI model may be a large language model (LLM).

In an embodiment, a non-transitory media is provided. The non-transitory media may include instructions that when executed by a processor cause the computer-implemented method to be performed.

In an embodiment, a system is provided. The system may include the non-transitory media and a processor, and may perform the computer-implemented method when the computer instructions are executed by the processor.

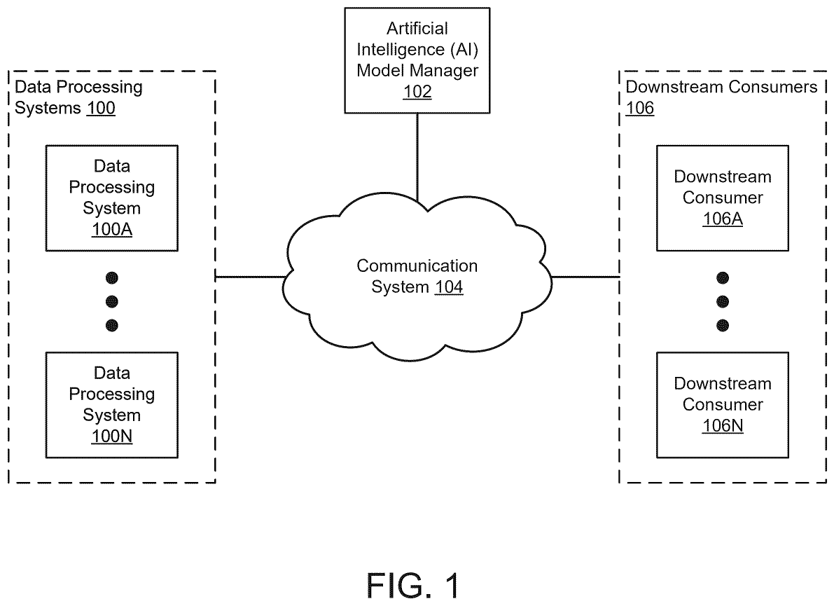

Turning to FIG. 1, a block diagram illustrating a system in accordance with an embodiment is shown. The system shown in FIG. 1 may provide for management of data processing systems that may provide, at least in part, computer-implemented services (e.g., to users of the system and/or devices operably connected to the system).

The computer-implemented services may include any type and quantity of computer-implemented services. The computer-implemented services may include, for example, database services, data processing services, electronic communication services, inference generation services, and/or any other services that may be provided using one or more computing devices. The computer-implemented services may be provided by, for example, data processing systems 100, AI model manager 102, downstream consumers 106, and/or any other type of devices (not shown in FIG. 1). Other types of computer-implemented services may be provided by the system shown in FIG. 1 without departing from embodiments disclosed herein.

The computer-implemented services may be provided, at least in part, using generative AI models and/or outputs obtained using the generative AI models. To do so, data processing systems 100 and/or AI model manager 102 may host any number of generative AI models.

To obtain the outputs, the generative AI models may be trained, using training data, to generate the outputs when provided with prompts (e.g., ingest data). The generative AI models may include large language models (LLMs) and, therefore, the outputs may include new instances of data created by the generative AI models based on learned associations from and/or an understanding of the training data. For example, the generative AI models may be trained using unstructured data, such as stories, essays, audio transcription, video description, and/or other types of human interpretable text, to generate outputs of the same. The outputs may be provided to downstream consumers 106 (e.g., client devices, data processing systems that manage computer systems and/or production systems) as part of providing the computer-implemented services.

However, the outputs may be provided to downstream consumers 106 as part of: (i) customer service requests (e.g., troubleshooting computer systems), (ii) data management processes (e.g., healthcare data, financial data), (iii) production system management processes (e.g., industrial applications), and/or (iv) other processes. The outputs, therefore, may be desired (e.g., by downstream consumers 106) to meet certain expectations. For example, downstream consumers 106 may expect the generative AI model and the outputs to comply with data privacy regulations (e.g., GDPR, HIPPA), may desire to mitigate unintended bias in outputs (e.g., when using the responses to make decisions based on financial data of consumers), and/or may otherwise wish to understand, audit, and/or modify operation of the generative AI models. If downstream consumers 106 are unable to determine whether the generative AI models and/or the outputs meet their expectations, a usefulness of the outputs to downstream consumers 106 may be reduced.

In general, embodiments disclosed herein may provide methods, systems, and/or devices for providing explainability information to downstream consumers along with the outputs generated by the generative AI models. The explainability information may describe (e.g., in human-interpretable text) why the generative AI model generated an output (e.g., may indicate relationships between portions of the prompt and portions of the output).

To do so, a prompt for a generative AI model may be obtained and used to obtain a first output from the generative AI model. To obtain the explainability information for the first output, an output explainability process may be performed using at least the prompt, the first output, and the generative AI model.

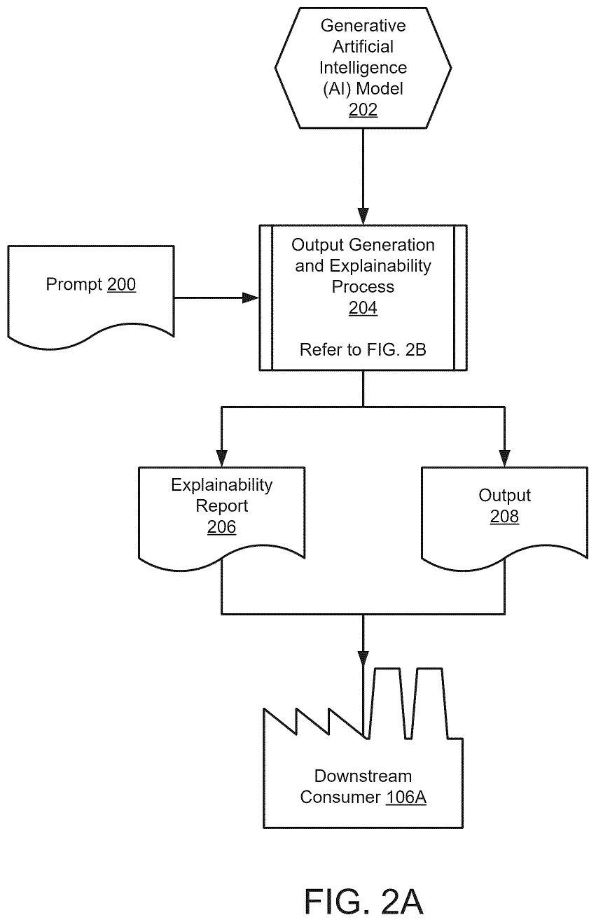

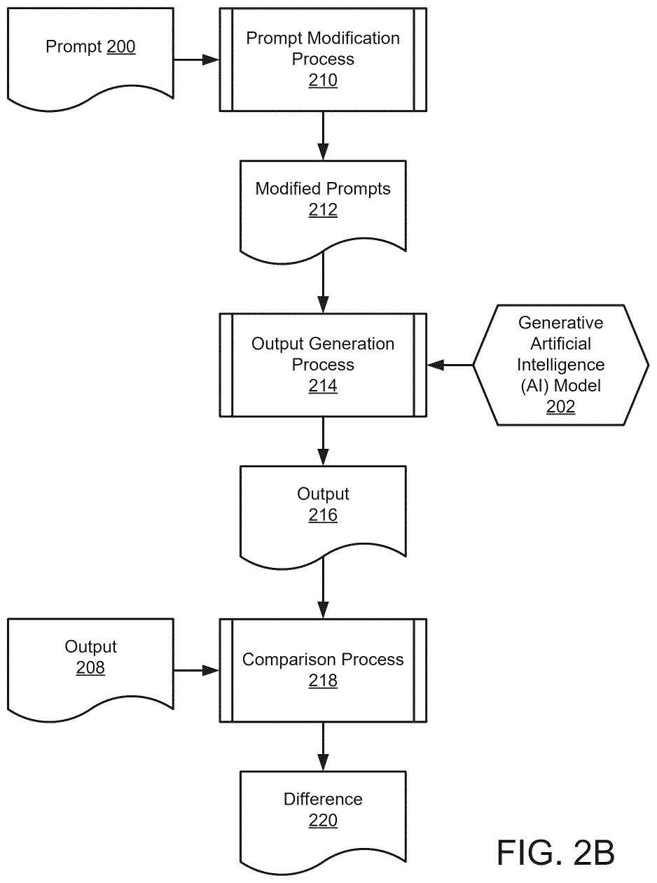

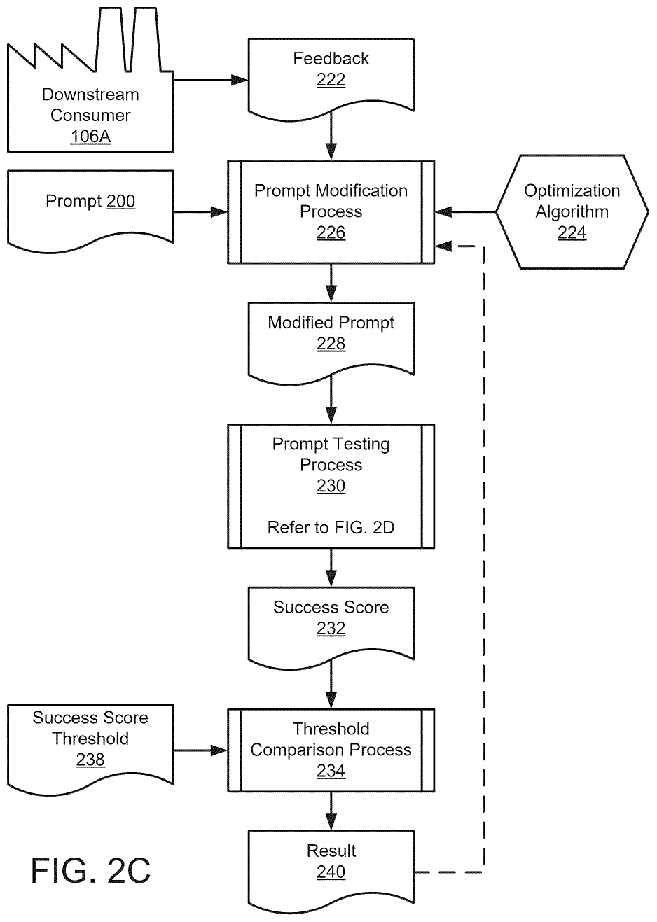

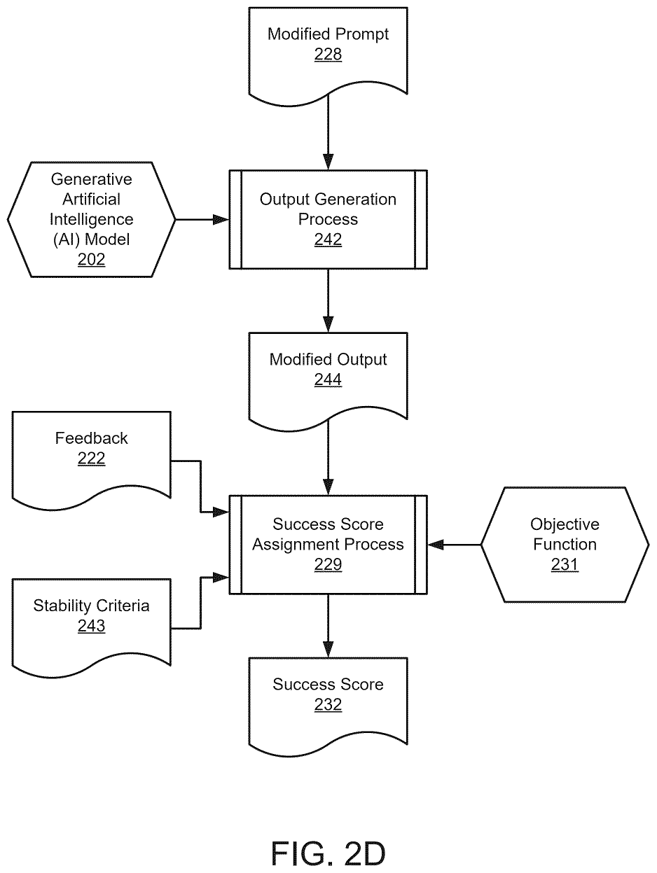

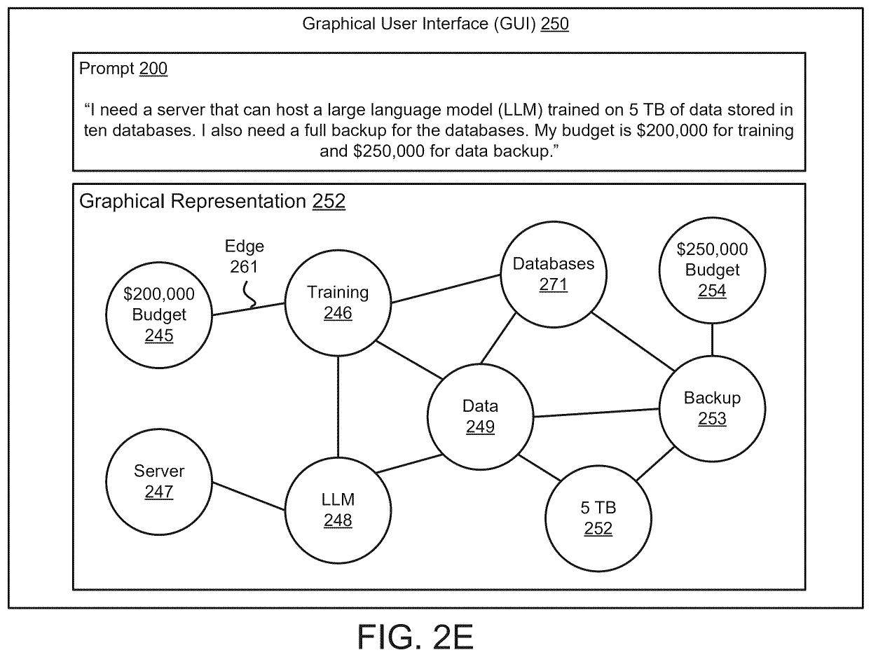

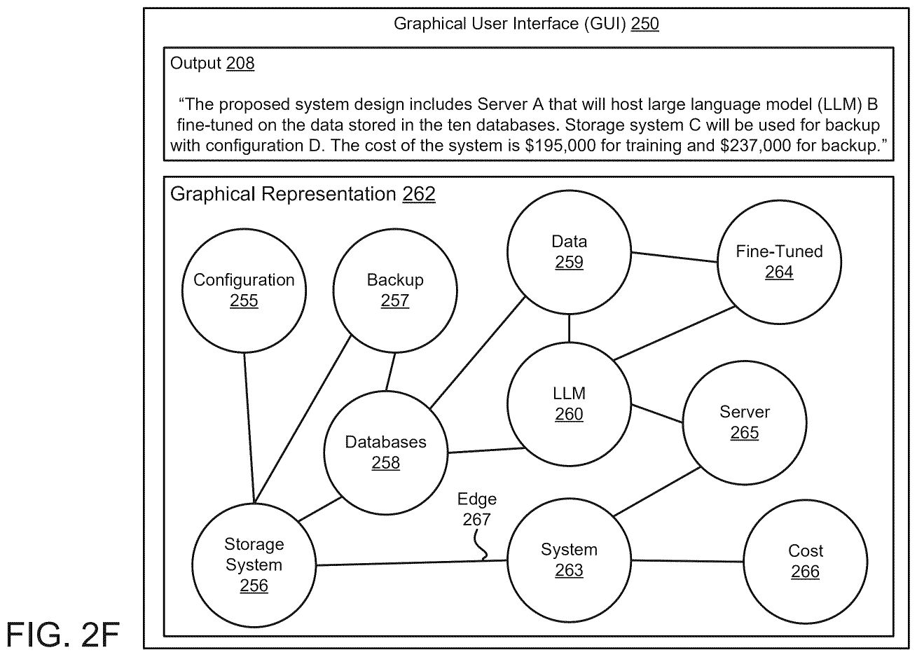

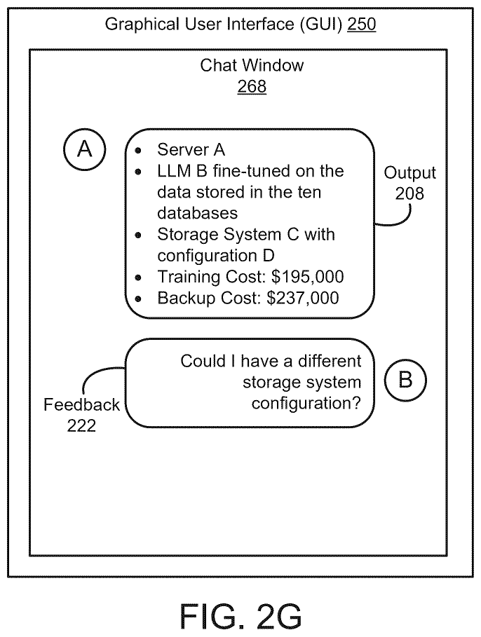

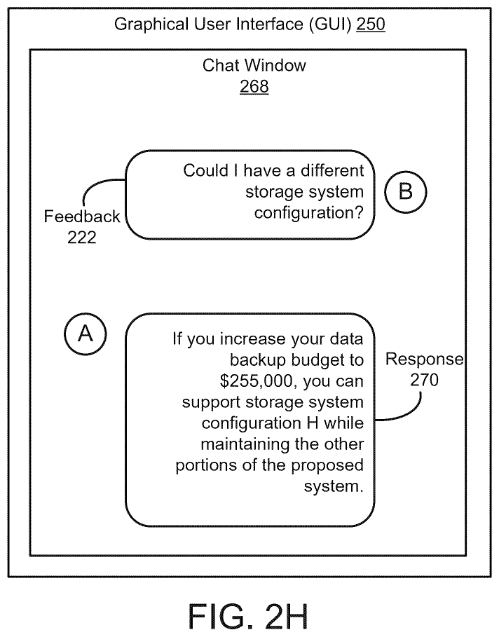

Performing the output explainability process may include: (i) iteratively perturbating the prompt to obtain perturbated prompts, (ii) evaluating, using the generative AI model, the perturbated prompts to obtain perturbated outputs, and (iii) comparing the first output to the perturbated outputs to identify the relationships between the portions of the prompt and the portions of the output. Refer to FIGS. 2A-2B for additional details regarding obtaining explainability reports.

However, iteratively perturbating the prompt may be computationally costly and/or may consume an undesirable quantity of time resources (e.g., based on a large number of iterations over the input space of the prompt). In addition, a perturbated output of the perturbated outputs may include both a desired modification to a portion of the output and undesirable corruption of other portions of the output. To provide explainability information to the downstream consumer while conserving resources (e.g., computational resources, time resources), a prompt optimization process may be performed while generating the explainability information.

For example, a prompt may be used as ingest for a generative AI model to obtain an output. A downstream consumer may provide feedback based on the output, the feedback indicating a desired modification to a portion of the output (e.g., removal of information content, replacement of information content with other information content).

The prompt optimization process may be performed using, at least in part, an optimization algorithm to obtain one or more modified prompts. The one or more modified prompts may be usable as ingest for the generative AI model to generate modified outputs that may meet: (i) the desired modification (e.g., indicated by the feedback), and (ii) stability criteria for maintaining integrity of other portions of the output. Refer to FIGS. 2C-2D for additional details regarding performing prompt optimization processes.

The one or more modified prompts may be provided to the downstream consumer (e.g., as part of the explainability information) and the one or more modified prompts may be used by the downstream consumer to make decisions.

Thus, embodiments disclosed herein may improve processes of explaining outputs generated by generative AI models to downstream consumers of the outputs. By iteratively perturbating the prompt as guided by an optimization algorithm, resources may be conserved while increasing a likelihood that computer-implemented services (e.g., based, at least in part, on the outputs and/or explainability information for the outputs) meet expectations of the downstream consumer.

To provide the above noted functionality, the system of FIG. 1 may include data processing systems 100, AI model manager 102, downstream consumers 106, and communication system 104. Each of these components is discussed below.

Data processing systems 100 may provide all, or a portion of, the computer-implemented services. Data processing systems 100 may include any number of data processing systems (e.g., 100A-100N) that may provide output generation services to downstream consumers 106. For example, a downstream consumer (e.g., 106A) may subscribe to output generation services provided by data processing system 100A and downstream consumer 106A may provide prompts (e.g., from clients, from owners of downstream consumer 106A, from employees of a company that owns downstream consumer 106A) to data processing system 100A as part of the subscribed services.

To provide computer-implemented services, data processing systems 100 may: (i) obtain prompts for generative AI models (e.g., hosted and/or operated by data processing systems 100), (ii) obtain, using the prompts and the generative AI models, outputs from the generative AI models, (iii) perform output explainability processes to obtain explainability reports for the outputs, (iv) provide the outputs and the explainability reports to downstream consumers 106 as part of providing computer-implemented services to downstream consumers 106, (v) receive feedback from downstream consumers 106 based on the outputs, (vi) perform, based on at least the feedback and the prompt, prompt optimization processes to obtain one or more modified prompts, (vii) provide the one or more modified prompts to downstream consumers 106 as part of providing the computer-implemented services, and/or (viii) perform other actions.. Refer to FIGS. 2A-2B for additional details regarding performing output explainability processes. Refer to FIGS. 2C-2D for additional details regarding performing prompt optimization processes.

AI model manager 102 may manage any number of AI models. For example, AI model manager 102 may: (i) obtain training data for AI models, (ii) train any number of AI models to obtain trained AI models, (iii) deploy trained AI models to other entities (e.g., data processing systems 100), (iv) update and/or modify trained AI models (e.g., fine-tune trained AI models based on additional training and/or production data), and/or (v) provide other AI model management services.

For example, AI model manager 102 may cooperatively provide at least a portion of the computer-implemented services to data processing systems 100 by: (i) obtaining training data from downstream consumers 106, (ii) training one or more AI models (e.g., generative AI models) using at least the training data obtained from downstream consumers 106 to obtain one or more trained AI models, (iii) deploying the one or more trained AI models to data processing systems 100 for use in providing output generation services for downstream consumers 106, and/or (iv) performing other actions.

Downstream consumers 106 may provide and/or consume all, or a portion of, the computer-implemented services. Downstream consumers 106 may include any number of downstream consumers (e.g., 106A-106N) and may include, for example, businesses, individuals, and/or devices (e.g., data processing systems) that may obtain outputs and/or other information based on the outputs (e.g., explainability information) as part of receiving the computer-implemented services.

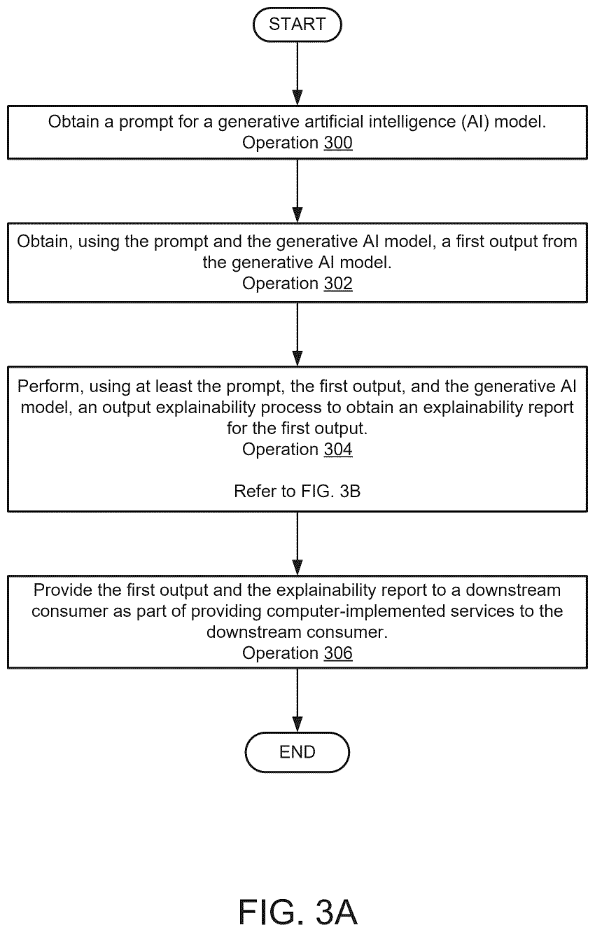

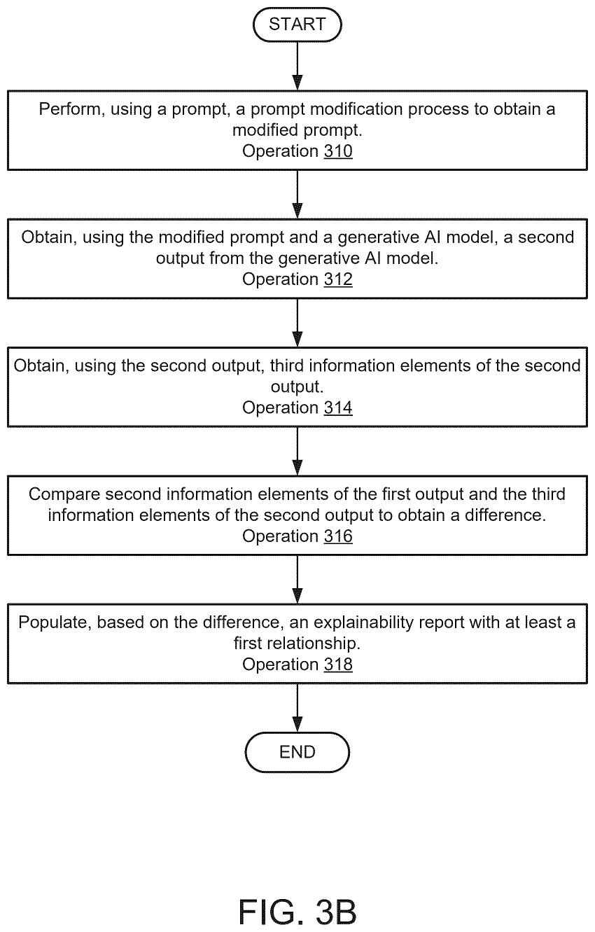

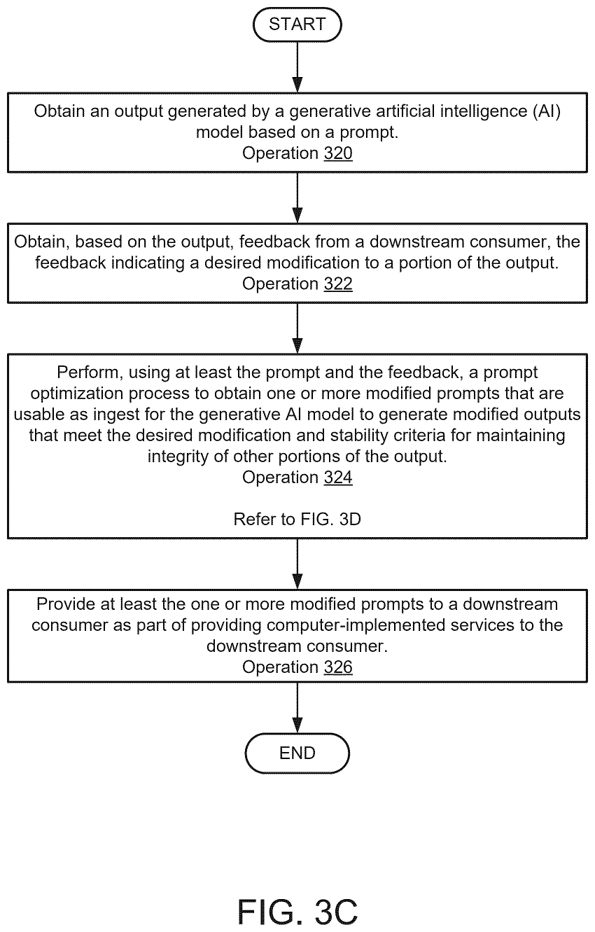

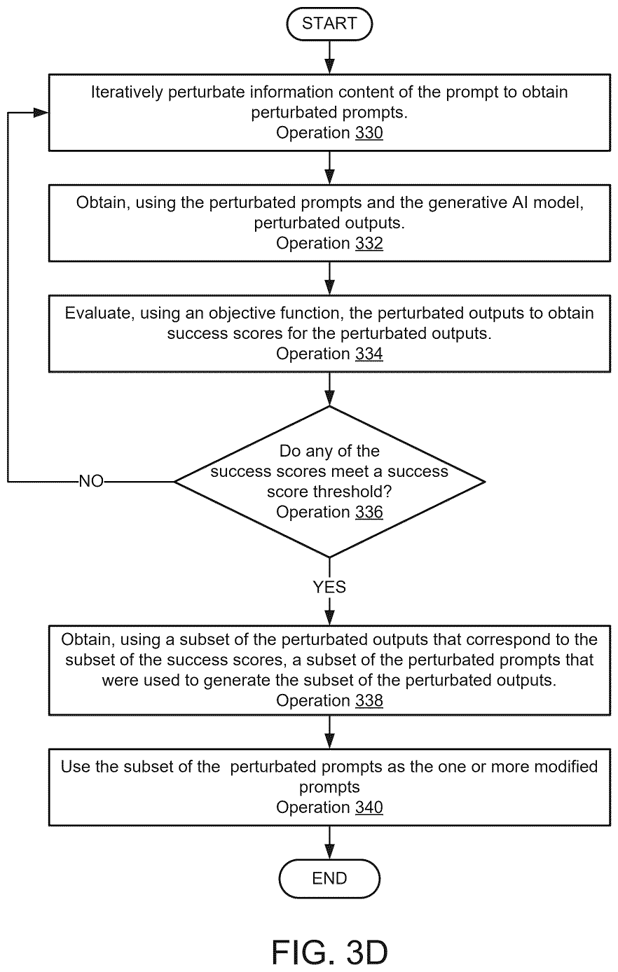

When providing their functionality, any of (and/or components thereof) data processing systems 100, AI model manager 102, and/or downstream consumers 106 may perform all, or a portion, of the actions and methods illustrated in FIGS. 2A-3D.

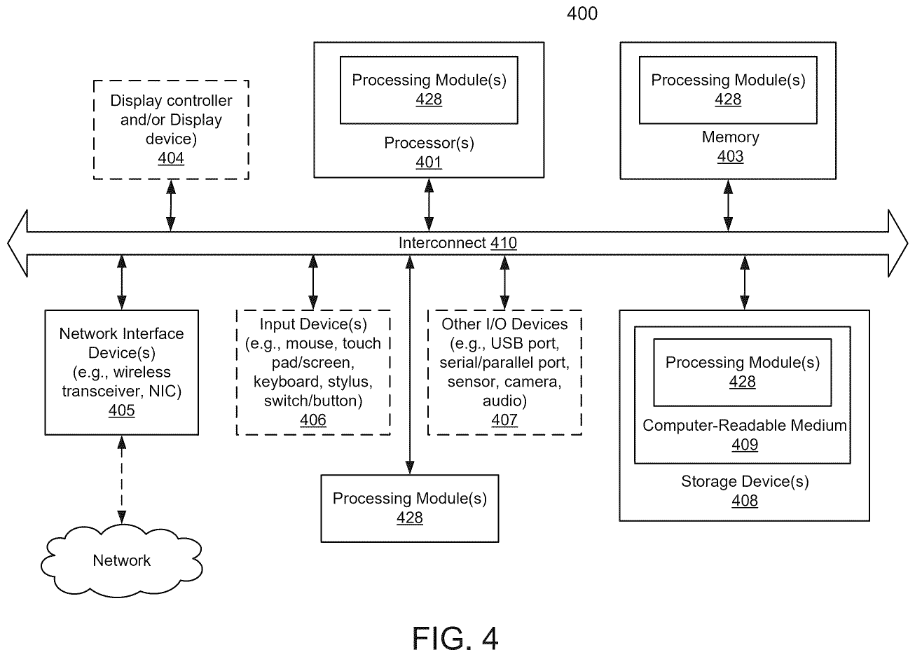

Any of (and/or components thereof) data processing systems 100, AI model manager 102, and downstream consumers 106 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to the discussion of FIG. 4.

Any of the components illustrated in FIG. 1 may be operably connected to each other (and/or components not illustrated) with communication system 104. In an embodiment, communication system 104 includes one or more networks that facilitate communication between any number of components. The networks may include wired networks and/or wireless networks (e.g., and/or the Internet). The networks may operate in accordance with any number and types of communication protocols (e.g., such as the internet protocol).

Communication system 104 may allow any of data processing systems 100, AI model manager 102, and downstream consumers 106 to communicate with one another (and/or with other devices not illustrated in FIG. 1). To provide its functionality, communication system 104 may be implemented with one or more wired and/or wireless networks. Any of these networks may be a radio access network (e.g., a cellular core network), a private network (e.g., the “Network” shown in FIG. 4), a public network, and/or may include the Internet. For example, data processing systems 100 may be operably connected to AI model manager 102 and downstream consumers 106 via the Internet. Data processing systems 100, AI model manager 102, downstream consumers 106, and/or communication system 104 may be adapted to perform one or more protocols for communicating via communication system 104.

While illustrated in FIG. 1 as including a limited number of specific components, a system in accordance with an embodiment may include fewer, additional, and/or different components than those illustrated therein.

While providing their functionality, any of data processing systems 100, AI model manager 102, and/or downstream consumers 106 may provide all or a portion of the methods shown in FIGS. 2A-3D.

To further clarify embodiments disclosed herein, data flow diagrams in accordance with an embodiment are shown in FIGS. 2A-2D. In these diagrams, flows of data and processing of data are illustrated using different sets of shapes. A first set of shapes (e.g., 200, 206, etc.) is used to represent data structures, a second set of shapes (e.g., 204, 210 etc.) is used to represent processes performed using and/or that generate data, a third set of shapes (e.g., 202) is used to represent generative AI models, algorithms, functions, and/or other types of models, and a fourth set of shapes (e.g., 106A) is used to represent downstream consumers.

Turning to FIG. 2A, a first data flow diagram in accordance with an embodiment is shown. The first data flow diagram may illustrate data used in and data processing performed in obtaining a generative AI model output and an explainability report for the output.

To obtain the output and the explainability report for the output, output generation and explainability process 204 may be performed. During output generation and explainability process 204: (i) prompt 200 and generative AI model 202 may be used to generate output 208 and (ii) at least prompt 200, generative AI model 202, and output 208 may be used to generate explainability report 206.

For example, generative AI model 202 may be an LLM (e.g., a neural network inference model) trained to generate language, understand language, and/or otherwise process requests related to languages. Generative AI model 202 may have been previously trained using training data and any training process (e.g., a global optimization process using gradient descent), the training data indicating goals for outputs generated by generative AI model 202 (e.g., outputs). Parameters of generative AI model 202 may be selected using an optimization process (e.g., an objective function may be defined in terms of the training data and outputs generated by generative AI model 202, and a global optimization method such as gradient descent may be used to identify parameters that most faithfully reproduce the trends in the training data). Once the parameters of generative AI model 202 are set, then generative AI model 202 may be used to generate outputs (e.g., responses) based on input data (e.g., prompts). Generative AI model 202 may be trained using other methods without departing from embodiments disclosed herein.

Prompt 200 may be intended to elicit an output from a generative AI model that includes information content desired by downstream consumer 106A (e.g., prompt 200 may be obtained from downstream consumer 106A). Prompt 200, for example, may include human-interpretable text and may include a question. For example, prompt 200 may include: (i) a request from a user for help assessing a malfunction of a computer system, (ii) a request from a customer for a product recommendation, (iii) a request from an employee of a business for a recommendation regarding a financial product (e.g., whether to extend a line of credit to a customer), and/or (iv) other requests. Refer to FIG. 2C for an example of prompt 200.

To generate output 208, prompt 200 may be provided to generative AI model 202 (e.g., prompt 200 may be fed into generative AI model 202 as ingest). Output 208 may be responsive to prompt 200. For example, output 208 may include human-interpretable text that indicates: (i) instructions for troubleshooting a malfunction of a computer system, (ii) a product recommendation, (iii) a financial product recommendation, and/or (iv) other information.

During output generation and explainability process 204, prompt 200, generative AI model 202, and output 208 may be used to obtain explainability report 206. Explainability report 206 may include human-interpretable text indicating relationships between information content of prompt 200 and information content of output 208. Explainability report 206 may be intended to explain, to downstream consumer 106A, why generative AI model 202 generated the information content of output 208 (e.g., why various decisions were made).

Explainability report 206 may be obtained by: (i) iteratively perturbating (e.g., modifying) information content of prompt 200 to obtain perturbated (e.g., modified) prompts, (ii) evaluating the perturbated prompts using generative AI model 202 to obtain perturbated outputs, (iii) using the perturbated prompts and the perturbated outputs to identify relationships between information elements of prompt 200 and information content of the perturbated outputs, and/or (iv) performing other actions. Refer to FIG. 2B for additional details regarding obtaining explainability report 206. Refer to FIG. 2E for an example graphical representation of prompt 200.

Output 208 and explainability report 206 may be provided to downstream consumer 106A as part of a computer-implemented service (e.g., via a chat interface). Downstream consumer 106A may subsequently use the output to make decisions.

Turning to FIG. 2B, a second data flow diagram in accordance with an embodiment is shown. The second data flow diagram may illustrate data used in and data processing performed during at least a partial expansion of output generation and explainability process 204 described in FIG. 2A. Explainability report 206 (e.g., described in FIG. 2A) may indicate relationships between first information elements of prompt 200 and second information elements of output 208. FIG. 2B may illustrate processes performed to obtain a first relationship of the relationships.

To generate the first relationship, prompt modification process 210 may be performed. During prompt modification process 210, a first information element of prompt 200 may be modified (e.g., removed, replaced with a replacement information element) to obtain modified prompt 212. The first information element may be selected based on: (i) a policy, (ii) an information element replacement schema, (iii) user feedback (e.g., a client may select the information element via a GUI), and/or (iv) via other methods.

The first information elements of prompt 200 may include any item, object, or entity in prompt 200 and the information elements may be identified via any algorithm, machine learning model, and/or rule set for natural language processing to extract information from text. Information elements may be extracted from other types of data modalities (e.g., images, audio, video) via object recognition algorithms or models. Information elements may be obtained via other methods without departing from embodiments disclosed herein.

For example, prompt 200 may include the following text: “My computer is not working. It keeps re-starting and overheating. I have computer A and I use operating system B, monitor C, keyboard D, and mouse E. How do I fix it?” The first information elements extracted from prompt 200 may, therefore, include: (i) computer A, (ii) operating system B, (iii) monitor C, (iv) keyboard D, (v) mouse E, (vi) re-starting, (vii) overheating, and (viii) not working.

The first information elements may be stored as a list, as a graphical representation of the first information elements, as human-interpretable text that summarizes the first information elements, and/or in other formats. Refer to FIG. 2E for an example graphical representation of prompt 200. The first information elements (e.g., the human-interpretable text, the graphical representation, the list) may be published to a client portal and may be accessible by a downstream consumer via a graphical user interface (GUI).

Continuing with the above example, information elements of prompt 200 may be iteratively removed (e.g., one information element may be removed at a time) to generate any number of modified prompts. Modified prompt 212 may be one of the modified prompts generated by removing a first information element of the first information elements (e.g., operating system B).

Prompt 200 may also be modified, for example, by replacing the first information element with a replacement information element (e.g., provided by a user via a GUI, obtained using a retrieval augmented generation (RAG) process and any number of data sources) to obtain modified prompt 212.

Modified prompt 212 and generative AI model 202 may be used to perform output generation process 214. During output generation process 214, modified prompt 212 may be provided as ingest to generative AI model 202 and output 216 may be obtained as an output from generative AI model 202.

Output 216 and output 208 (e.g., described in FIG. 2A) may be used to perform comparison process 218. During comparison process 218, second information elements of output 208 may be compared to third information elements of output 216. To do so, the second information elements and the third information elements may be obtained using natural language processing and/or other algorithms for data extraction from text. Lists, human-interpretable text summaries, and/or graphical representations may be generated and published to a client portal (e.g., accessible by downstream consumers via a GUI).

Difference 220 may be obtained via any data comparison tool, algorithm, and/or model trained to compare text and/or graphs. For example, a set of the second information elements (e.g., displayed as human-interpretable text, displayed as a graphical representation) may be compared to a set of the third information elements (e.g., displayed as human-interpretable text, displayed as a graphical representation) to identify any of the second information elements that do not appear in the list of the third information elements. In addition, a second graphical representation of the second information elements may include any number of second nodes and a third graphical representation of the third information elements may also include any number of third nodes. During comparison process 218, the second nodes may be compared to the third nodes to identify any of the second nodes that do not appear in the third graphical representation.

One or more of the third nodes may also not appear in the second graphical representation (e.g., removal and/or replacement of a portion of the prompt may result in new information elements appearing in output 216 that did not appear in output 208).

Difference 220, therefore, may be used to establish a first relationship of the relationships included in explainability report 206 (e.g., described in FIG. 2A). The first relationship may indicate a correlation between the first information element (e.g., the portion of the prompt that was removed and/or replaced during prompt modification process 210) and difference 220 (e.g., the portion of output 216 that differs from output 208).

The processes described in FIG. 2B may be repeated any number of times (e.g., each node of a graphical representation of prompt 200 may be removed one at a time) and any number of relationships may, therefore, be generated and added to explainability report 206.

Thus, by implementing the data flow shown in FIG. 2A-2B, a system in accordance with embodiments disclosed herein may be used to generate outputs from generative AI models based on prompts and explainability reports for the outputs. By iteratively modifying prompts and obtaining modified outputs for each modified prompt, the modified outputs may be compared to extract relationships between information elements of the prompt and information elements of the output. Consequently, the relationships may be included in the explainability report and the explainability report may be used to understand why the output was generated by the generative AI model thereby increasing a reliability and/or usefulness of the output to the downstream consumer.

Turning to FIG. 2C, a third data flow diagram in accordance with an embodiment is shown. The third data flow diagram may illustrate data used in and data processing performed to obtain explainability information (e.g., one or more modified prompts) based, at least in part, on: (i) the prompt (e.g., prompt 200 described in FIG. 2A) and (ii) feedback from downstream consumer 106A (e.g., feedback 222). Performing the processes shown in FIG. 2C may be less computationally costly than performing the processes shown in FIG. 2B. Therefore, to conserve computational and time resources, the processes shown in FIG. 2C may be performed in place of the generation of the explainability report as shown in FIGS. 2A-2B.

To obtain the explainability information, prompt modification process 226 may be performed. Consider a scenario in which at least output 208 (e.g., described in FIG. 2A and generated using prompt 200 and generative AI model 202) is provided to downstream consumer 106A. Downstream consumer 106A may provide, in response to output 208, feedback 222. Feedback 222 may indicate a desired modification to a portion of output 208 (e.g., removal of information content of the portion of output 208, replacement of the information content of the portion of output 208 with other information content).

For example, output 208 may include a product recommendation for a computer system, the computer system including a storage device with a first configuration. Feedback 222 may indicate that downstream consumer 106A would prefer a different storage device and/or may indicate that downstream consumer 106A would prefer a different configuration for the storage device. Feedback 222, therefore, may define goals for modifying prompt 200 to obtain the one or more modified prompts.

Feedback 222 may be entered (e.g., by downstream consumer 106A) into a GUI. Output 208, graphical representations of output 208 and/or prompt 200, and/or other information may be displayed to downstream consumer 106A via the GUI. Refer to FIGS. 2E-2H for examples and additional information regarding the GUI.

During prompt modification process 226, prompt 200, feedback 222, and optimization algorithm 224 may be used to obtain modified prompt 228. Optimization algorithm 224 may include any optimization algorithm (e.g., gradient descent, stochastic optimization techniques, evolutionary algorithms, hyperparameter optimization, bacterial foraging optimization (BFO), metaheuristic optimization). Optimization algorithm 224 may be used to guide iterative modification of prompt 200 as part of an optimization process to achieve a goal (e.g., minimizing an objective function). Therefore, prompt modification process 226 may include any number of iterative modifications to prompt 200. A first modification of the iterative modifications may be performed based on a rule set included in optimization algorithm 224 (e.g., may be random, may be based on information elements of feedback 222).

Optimization algorithm 224 may also indicate, based on feedback 222, that a first modification to prompt 200 is to include: (i) removal of information content of a portion of prompt 200, (ii) replacement of the information content of the portion of prompt 200 with other information content (e.g., provided as part of feedback 222, generated via a retrieval augmented generation (RAG) process), and/or (iii) other modifications.

Modified prompt 228 may be used to perform prompt testing process 230. During prompt testing process 230, modified prompt 228 may be used to generate a modified output and the modified output may be assigned a success score (e.g., success score 232) using an objective function. Refer to FIG. 2D for additional details regarding performing prompt testing process 230.

Success score 232 may indicate a degree to which a modified output corresponding to modified prompt 228 (e.g., generated by feeding modified prompt 228 into generative AI model 202 as part of prompt testing process 230) meets: (i) a desired modification to a portion of the modified output indicated by feedback 222, and (ii) stability criteria for maintaining integrity of other portions of the modified output. Refer to FIG. 2D for additional details regarding the stability criteria.

Success score 232 may be represented via any scoring system (e.g., a number between 1-10 where 1 indicates a lowest success score and 10 indicates a highest success score, a percent success with a higher percentage indicating a higher degree of minimizing the objective function).

Success score 232 and success score threshold 238 may be used to perform threshold comparison process 234 to obtain result 240. Success score threshold 238 may be obtained from a downstream consumer, a subject matter expert (SME), may be generated by an inference model, and/or may be obtained from any other source. Success score threshold 238 may indicate a minimum success score that is acceptable to be provided to downstream consumer 106A. For example, if success scores are assigned based on a scale of 1-10 with 1 being the lowest success score and 10 being the highest success score, success score threshold 238 may indicate that any success scores of 8 or higher may be acceptable to be provided to downstream consumer 106A.

Therefore, if success score 232 meets success score threshold 238, result 240 may indicate that modified prompt 228 is acceptable and is to be provided to downstream consumer 106A.

If success score 232 does not meet success score threshold 238, result 240 may indicate that modified prompt 228 is not acceptable. Result 240 may include other information usable (e.g., by optimization algorithm 224) to perform additional iterative modifications of prompt 200. If modified prompt 228 is not acceptable, result 240 may be used to perform a second iterative modification of prompt modification process 226. The dashed arrow connecting result 240 to prompt modification process 226 indicates a looping process that may occur if result 240 indicates an unacceptable result.

Therefore, optimization algorithm 224 may be used to obtain a second modified prompt (not shown). Optimization algorithm 224 may utilize modified prompt 228, result 240, and/or other information to accomplish its goal (e.g., minimize the objective function).

Consequently, prompt modification process 226, prompt testing process 230, and threshold comparison process 234 may be iteratively repeated any number of times until one or more (e.g., downstream consumer 106A and/or another entity may specify the number of modified prompts that are to be generated) modified prompts are generated that correspond to success scores that meet success score threshold 238. The one or more modified prompts may be provided to downstream consumer 106A as part of providing the computer-implemented services to downstream consumer 106A.

Turning to FIG. 2D, a fourth data flow diagram in accordance with an embodiment is shown. The fourth data flow diagram may illustrate data used in and data processing performed during prompt testing process 230 described in FIG. 2C.

During prompt testing process 230, output generation process 242 and success score assignment process 229 may be performed. During output generation process 242, modified prompt 228 (e.g., described in FIG. 2C) and generative AI model 202 (e.g., described in FIG. 2A) may be used to obtain modified output 244. Output generation process 242 may include methods similar to those described with respect to output generation process 214 in FIG. 2B.

During success score assignment process 229, modified output 244, feedback 222, stability criteria 243, and objective function 231 may be used to obtain success score 232. Refer to FIG. 2C for a description of success score 232.

Objective function 231 may include any mathematical function to calculate a success score (e.g., success score 232) based on a number of constraints. The constraints may be determined using information elements of feedback 222 and stability criteria 243. For example, objective function 231 may determine a degree to which modified output 244 meets feedback 222 and stability criteria 243 (e.g., weights for different portions of objective function 231 may be assigned using feedback 222 and stability criteria 243 based on relative importance of meeting feedback 222 and stability criteria 243). Therefore, objective function 231 may assign success scores to modified outputs based on: (i) degrees to which the modified (e.g., perturbated) outputs meet the desired modification (e.g., of feedback 222) and (ii) degrees to which the modified outputs meet the stability criteria.

For example, feedback 222 may indicate a portion of output 208 that is desired to be modified. Stability criteria 243 may define a maximum acceptable difference between information elements of the output and information elements of modified output 244. For example, integrity of other portions of output 208 (e.g., other than the portion desired to be modified) may be desired to be maintained during the optimization process. Therefore, stability criteria 243 may be used to compare the other portions of output 208 to corresponding portions of modified output 244. The maximum acceptable difference may be based on any similarity measure (e.g., Euclidean distance, Manhattan distance, percent difference) and differences may be obtained via any data comparison methods (e.g., graph comparison, text comparison).

During success score assignment process 229, a degree to which modified output 244 meets the desired modification of feedback 222 may be determined. To do so, a first difference may be obtained between information elements of feedback 222 and information elements of modified output 244. In addition, during success score assignment process 229, a second difference may be obtained between other portions of output 208 (e.g., portions that do not include the desired modification) and other portions of modified output 244 (e.g., portions that do not include the desired modification).

Obtaining the first difference and the second difference may include executing any difference algorithm to compare data sets (e.g., to compare information content of output 208 to information content of modified output 244). For example, a first graphical representation of output 208 may be obtained and a second graphical representation of modified output 244 may be obtained. The first graphical representation and the second graphical representation may be generated using any graph generation method.

The first graphical representation may include: (i) first nodes that correspond to information elements of output 208, and (ii) first edges that represent relationships between the first nodes. The second graphical representation may include: (i) second nodes that correspond to information elements of modified output 244, and (ii) second edges that represent relationships between the second nodes.

A graph comparison process may be performed to identify the first difference and the second difference and objective function 231 may assign success score 232 based on at least the first difference and the second difference. For example, a success score may be higher for a modified output that more closely meets feedback 222 and stability criteria 243 than another modified output.

Stability criteria 243 may indicate: (i) a threshold for a maximum acceptable value for the second difference, (ii) a rule set indicating that a higher degree of maintaining integrity of the other portions of output 208 is to be associated with a higher success score for a modified output, and/or (iii) may include other information. Refer to FIG. 2F for an example graphical representation of output 208.

Thus, by implementing the data flow shown in FIGS. 2C-2D, a system in accordance with embodiments disclosed herein may be used to identify one or more modified prompts that may meet expectations of downstream consumers based on feedback provided by the downstream consumers and stability criteria. By iteratively modifying prompts using an optimization algorithm, a computational cost of iteratively modifying and testing prompt modifications may be reduced. By providing the one or more modified prompts to the downstream consumers, computer-implemented services provided, at least in part, based on the outputs may have an increased likelihood of meeting expectations of downstream consumers of the outputs.

Any of the processes illustrated using the second set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor based devices (e.g., computer chips).

Any of the data structures illustrated using the first set of shapes may be implemented using any type and number of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

Turning to FIG. 2E, an example of prompt 200 (e.g., described in FIG. 2A) and a graphical representation of prompt 200 (e.g., graphical representation 252) are shown. A customer (e.g., downstream consumer 106A described in FIG. 2A) may access graphical user interface (GUI) 250 through which the customer may provide a request for a product (e.g., a computer system) recommendation.

The customer may open a chat window as part of functionality of GUI 250 and may enter prompt 200 into the chat window. Prompt 200 may include the following text: “I need a server that can host a large language model (LLM) trained on 5 terabytes (TB) of data stored in ten databases. I also need a full backup for the databases. My budget is $200,000 for training and $250,000 for data backup.”

Graphical representation 252 may be displayed to a downstream consumer (e.g., the customer) via GUI 250. To obtain graphical representation 252, first information elements of prompt 200 may be represented as nodes (e.g., 245, 246, 247, 248, 249, 252, 253, 254, and 271) with edges between the nodes (e.g., edge 261) to indicate relationships between the first information elements. Refer to the description of FIG. 2A for additional details regarding obtaining information elements.

For example, the information elements extracted from prompt 200 may include: (i) “$200,000 budget” shown as node 245, (ii) “training” shown as node 246, (iii) “server” shown as node 247, (iv) “LLM” shown as node 248, (v) “data” shown as node 249, (vi) “databases” shown as node 271, (vii) “5 TB” shown as node 252, (viii) “backup” shown as node 253, and “$250,000 budget” shown as node 254.

The edges between the nodes (e.g., 261) may represent relationships (e.g., data dependencies, data flows, entities that cooperatively perform workloads). For example, edge 261 may connect node 245 and node 246 to indicate that the $200,000 budget is allocated for training.

Descriptive information may be embedded in the nodes as internal representations (not shown). For example, information regarding the databases (e.g., a type of the databases, a number of nodes of the databases) may be included in an internal representation of node 271. The internal representation may be shown, for example, if a user selects node 271 via GUI 250.

Turning to FIG. 2F, an example of output 208 (e.g., described in FIG. 2A) and a graphical representation of output 208 (e.g., graphical representation 262) are shown. Output 208 and/or graphical representation 262 may be displayed to the customer via GUI 250 (e.g., via a chat window, via other functionality of GUI 250).

Output 208 may include the following text: “The proposed system design includes Server A that will host large language model (LLM) B fine-tuned on the data stored in the ten databases. Storage system C will be used for backup with configuration D. The cost of the system is $195,000 for training and $237,000 for backup.”

To obtain graphical representation 262, second information elements of output 208 may be represented as nodes (e.g., 255, 256, 257, 258, 259, 260, 263, 264, 265, and 266) with edges between the nodes (e.g., 267) to indicate relationships between the second information elements.

For example, the information elements extracted from prompt 200 may include: (i) “configuration” shown as node 255, (ii) “storage system” shown as node 256, (iii) “backup” shown as node 257, “databases” shown as node 258, “data” shown as node 259, “LLM” shown as node 260, “system” shown as node 263, “fine-tuned” shown as node 264, “server” shown as node 265, and (iv) “cost” shown as node 266.

The edges between the nodes may represent relationships (e.g., data dependencies, data flows, entities that cooperatively perform workloads). For example, edge 267 may indicate that the storage system (node 256) is part of the system (node 263). Descriptive information may be embedded in the nodes as internal representations (not shown).

In FIGS. 2E and 2F, a number of nodes and edges are shown for illustrative purposes. It may be appreciated that any number of additional or fewer nodes and/or edges may be included in a graphical representation of text without departing from embodiments disclosed herein.

Turning to FIG. 2G, an example of a chat window through which the customer may request the product recommendation is shown (e.g., chat window 268). Chat window 268 may be displayed to the customer via GUI 250 and the customer may be able to provide feedback via chat window 268.

For example, output 208 may be shown in chat window 268. The letter “A” may be shown next to output 208 in a circle to indicate a first entity (e.g., a manufacturer/vendor for the product), the first entity having provided output 208 to the customer via GUI 250. Feedback 222 (e.g., described in FIG. 2C) may be entered by the customer and entered into chat window 268. Feedback 222 is shown next to the letter “B” in a circle to indicate that a second entity (e.g., the customer) entered feedback 222.

Returning to FIG. 2E, portions of graphical representation 252 may be iteratively modified using feedback 222 and optimization algorithm 224 (e.g., described in FIG. 2C). Graphical representation 252 may be modified via: (i) removal of a node (e.g., removing node 245), (ii) removal of a portion of an internal representation of a node (e.g., removing a number of nodes of databases indicated by an internal representation of node 271), (iii) replacement of a node with a replacement node (e.g., swapping the $200,000 budget of node 245 with a new node that includes a $250,000 budget), (iv) replacement of a portion of an internal representation of a node with a replacement internal representation (e.g., replacing a type of LLM indicated by an internal representation of node 248 with another type of LLM), and/or (v) other modifications.

Various modified prompts may be obtained via these iterative modifications and the modified prompts may be used to generate modified outputs (e.g., via ingestion by generative AI model 202 described in FIG. 2A).

Returning to FIG. 2F, graphical representations of the modified outputs may be obtained via methods similar to those described with respect to generating graphical representation 262. The graphical representations of the modified outputs may be compared to graphical representation 262 as part of success score assignment process 229 described in FIG. 2D.

If, for example, the desired modification to output 208 includes changing configuration D of storage system C, the graphical representation of the modified output may not include node 255 (e.g., or an internal representation of node 255 may be changed to include a different type of configuration) (not shown).

Therefore, graphical representations may be obtained for each modified output obtained using a modified prompt (not shown). For example, the desired modification may be met (e.g., an internal representation of node 255 may be changed to include a descriptor for a different configuration). However, an internal representation of node 266 may indicate a cost that no longer falls within the budget for the system. Therefore, the integrity of the other portions of the graphical representation may not meet the stability criteria (e.g., described in FIG. 2D) and the modified output may be rejected.

If the structure of nodes 256, 257, 258, 259, 260, 263, 264, 265, and 266 remain stable (e.g., to an extent considered acceptable based on the stability criteria) and node 255 is changed to meet the desired modification, a corresponding modified output may be accepted.

Turning to FIG. 2H, a modified prompt may be provided to the customer via chat window 268. The modified prompt may correspond to a modified output that was assigned a success score that met success score threshold 238 described in FIG. 2C. Response 270 may include the modified prompt and may include the following text: “If you increase your data backup budget to $255,000, you can support storage system configuration H while maintaining the other portions of the proposed system.” Response 270 may be generated by feeding the modified prompt into an LLM, and/or via other methods.

As discussed above, the components of FIG. 1 may perform various methods to manage a data processing system. FIGS. 3A-3D illustrate methods that may be performed by the components of the system of FIG. 1. In the diagrams discussed below and shown in FIGS. 3A-3D, any of the operations may be repeated, performed in different orders, and/or performed in parallel with or in a partially overlapping in time manner with other operations.

Turning to FIG. 3A, a first flow diagram illustrating a method of providing computer-implemented services using generative AI models in accordance with an embodiment is shown. The method may be performed, for example, by any of the components of the system of FIG. 1, and/or other components not shown therein.

At operation 300, a prompt for a generative AI model may be obtained. Obtaining the prompt for the generative AI model may include: (i) reading the prompt from storage, (ii) receiving (e.g., via a communication system) the prompt from another entity, (iii) receiving the prompt as part of user feedback submitted via a GUI (e.g., a chat interface displayed on the user's device), and/or (iv) other methods.

At operation 302, a first output from the generative AI model may be obtained using the prompt and the generative AI model. Obtaining the first output may include: (i) feeding the prompt into the generative AI model as ingest and obtaining the first output from the generative AI model, (ii) providing the prompt to another entity responsible for operating the generative AI model and receiving the first output from the entity in response, and/or (iii) other methods.

At operation 304, an output explainability process may be performed using at least the prompt, the first output, and the generative AI model to obtain an explainability report for the first output. The explainability report may indicate relationships between first information elements of the prompt and second information elements of the first output. The relationships may be based, at least in part, on a second output generated by the generative AI model using a modified prompt and the modified prompt may be based on the prompt.

Performing the output explainability process may include: (i) iteratively perturbating information content of the prompt to obtain perturbated prompts, (ii) evaluating the perturbated prompts using the generative AI model to obtain perturbated outputs, (iii) using the perturbated prompts and the perturbated outputs to identify the relationships between the first information elements and the second information elements, and/or (iv) other methods.

Iteratively perturbating the information content of the prompt may include: (i) during a first perturbation of the information content of the prompt, removing a first information element of the first information elements to obtain a first modified prompt, (ii) during a second perturbation of the information content of the prompt, removing a second information element of the first information elements to obtain a second modified prompt, and/or (iii) other methods. Iteratively perturbating the information content of the prompt may include any number of perturbations to obtain any number of perturbated prompts.

Iteratively perturbating the information content of the prompt may also include: (i) replacing the first information element of the first information elements with a first replacement information element to obtain a third modified prompt, (ii) replacing the first information element of the first information elements with a second replacement information element to obtain a fourth modified prompt, and/or (iii) other methods.

Evaluating the perturbated prompts using the generative AI model to obtain perturbated outputs may include: (i) obtaining the perturbated prompts (e.g., the modified prompts), (ii) feeding each perturbated prompt of the perturbated prompts into the generative AI model to obtain the perturbated outputs, (iii) providing the perturbated prompts to another entity responsible for operating the generative AI model, and/or (iv) other methods.

Using the perturbated prompts and the perturbated outputs to identify the relationships between the first information elements and the second information elements may include: (i) obtaining the first information elements (e.g., using natural language processing and/or object recognition algorithms to extract data from text or images), (ii) obtaining information elements for each of the perturbated outputs (e.g., via methods similar to those described with respect to obtaining the first information elements), (iii) comparing the first information elements of the prompt to information elements of each of the perturbated outputs to obtain differences between the first information elements and the information elements of each of the perturbated outputs, and/or (iv) establishing, based on the differences and information elements that were modified to generate the perturbated prompts, the relationships.

Refer to FIG. 3B for an example iteration (e.g., one instance of perturbating the prompt to obtain a perturbated prompt, evaluating the perturbated prompt using the generative AI model to obtain a perturbated output, and using the perturbated output to establish a first relationship of the relationships). Refer to FIG. 2B for additional details regarding using differences to establish relationships between information elements of a prompt and information elements of an output.

At operation 306, the first output and the explainability report may be provided to a downstream consumer as part of providing computer-implemented services to the downstream consumer. Providing the first output and the explainability report to the downstream consumer may include: (i) transmitting the first output and the explainability report to the downstream consumer in the form of a message via a communication system, (ii) displaying the first output and the explainability report to the downstream consumer via a GUI (e.g., refer to FIGS. 2E-2H for examples of displaying information via the GUI), (iii) storing the first output and the explainability report in a shared storage with the downstream consumer, and/or (iv) other methods.

The method may end following operation 306.

Turning to FIG. 3B, a second flow diagram illustrating a method of providing computer-implemented services using generative AI models in accordance with an embodiment is shown. The method may be performed, for example, by any of the components of the system of FIG. 1, and/or other components not shown therein. The method shown in FIG. 3B may be at least a partial expansion of operation 304. For example, the operations shown in FIG. 3B may include a first iteration of multiple iterations included in operation 304.

At operation 310, a prompt modification process may be performed using the prompt to obtain a modified prompt. Performing the prompt modification process may include: (i) obtaining, using the prompt and the first output (e.g., obtained using the generative AI model and the prompt in operation 302 of FIG. 3A), first information elements of the prompt and second information elements of the first output, and/or (ii) other methods.

Performing the prompt modification process may also include at least one action selected from a list of actions consisting of: (i) removing a first information element of the first information elements to obtain the modified prompt, and (ii) replacing the first information element with a replacement information element to obtain the modified prompt.

Obtaining the first information elements and the second information elements may include: (i) utilizing an algorithm, model, and/or rule set to perform natural language processing and/or object recognition to extract the first information elements from the prompt and the second information elements from the first output, (ii) providing the prompt and the first output to another entity responsible for extracting the first information elements and the second information elements, and/or (iii) other methods.

Removing the first information element of the first information elements to obtain the modified prompt may include: (i) selecting the first information element (e.g., randomly, based on a schema, based on feedback from a downstream consumer), (ii) deleting the first information element from the first information elements, (iii) using a model (e.g., a second generative AI model) to create the modified prompt based on the remaining information elements, and/or (iv) other methods.

Replacing the first information element with the replacement information element to obtain the modified prompt may include: (i) deleting the first information element from the prompt, (ii) adding the replacement information element to the prompt to replace the first information element (e.g., a first budget may be replaced with a second budget), (iii) providing the prompt and the replacement information element to another entity responsible for replacing the first information element, and/or (iv) other methods.

If the at least one action performed as part of the prompt modification process includes replacing the first information element, a replacement information element may be obtained prior to replacing the first information element. The replacement information element may be obtained based on the first information element and an information element replacement schema.

Obtaining the replacement information element may include: (i) obtaining the information element replacement schema (e.g., from storage, from another entity via a communication system, from a downstream consumer via a GUI), (ii) reading instructions from the information element replacement schema (e.g., for selecting the first information element, for obtaining the replacement information element), (iii) selecting, based on the information element replacement schema, the first information element (e.g., randomly, based on a hierarchy for preferential selection of different types of information elements), (iv) performing a search process (e.g., a lookup process, a RAG process) using the first information element to obtain one or more replacement information elements (e.g., from a database, from another entity, from any number of other data sources), and/or (v) other methods.

Performing the prompt modification process may also include, if the at least one action includes replacing the first information element: (i) displaying, via a GUI, at least the first information elements to a user (e.g., a client, a downstream consumer), (ii) obtaining, via an interaction with the GUI, feedback from the user that includes the replacement information element, and/or (iii) other methods.

Displaying at least the first information elements to the user may include: (i) obtaining a first graphical representation of the first information elements, (ii) populating the GUI with the first graphical representation, and/or (iii) other methods.

The first graphical representation may include: (i) a first set of nodes that correspond to the first information elements, and (ii) first edges that indicate relationships between the first set of the nodes.

Obtaining the first graphical representation may include: (i) executing a graph generation algorithm or feeding the first information elements into an inference model to obtain the first set of nodes and internal representations (e.g., descriptors) for the first set of nodes, (ii) performing an analysis process, using the first set of the information elements and supplementary information, to obtain the first edges (e.g., indicating patterns of data flows, data dependencies, workload performance for various entities), and/or (iii) other methods.

Populating the GUI with the first graphical representation may include: (i) uploading the first graphical representation (e.g., via an application programming interface) so that the first graphical representation is available to the user via the GUI, (ii) providing the first graphical representation to another entity responsible for uploading the first graphical representation to the GUI, and/or (iii) other methods.

Obtaining the feedback from the user may include: (i) receiving (e.g., via an application programming interface) a notification that the user provided the user feedback (e.g., via selecting one or more buttons on the GUI, via entering text into a text box on the GUI), (ii) reading the user feedback from storage, the user feedback being previously extracted from the GUI, and/or (iii) other methods. Refer to FIG. 2G for an example of providing user feedback via the GUI.

At operation 312, a second output may be obtained from the generative AI model using the modified prompt and the generative AI model. Obtaining the second output may include: (i) feeding the second output into the generative AI model and obtaining the second output from the generative AI model in response, (ii) providing the second output to another entity responsible for operating the generative AI model and receiving the second output in response from the other entity, and/or (iii) other methods.

At operation 314, third information elements of the second output may be obtained using the second output. Obtaining the third information elements may include: (i) performing any algorithm, model, or rule set for extracting information from text or images (e.g., object recognition, natural language processing) to generate the third information elements based on the second output, (ii) reading the third information elements from storage, (iii) providing the second output to another entity responsible for extracting the third information elements, and/or (iv) other methods.

At operation 316, second information elements of the first output may be compared to the third information elements of the second output to obtain a difference. Comparing the second information elements and the third information elements may include: (i) obtaining a second graphical representation of the second information elements, (ii) obtaining a third graphical representation of the third information elements, (iii) identifying, using the second graphical representation and the third graphical representation, one or more nodes of the second set of the nodes that is not present in the third graphical representation, and/or (iv) other methods.

Obtaining the second graphical representation may include methods similar to those described with respect to generating the first graphical representation (e.g., feeding the second information elements into a graph generation algorithm or model).

Obtaining the third graphical representation may also include method similar to those described with respect to generating the first graphical representation.

Identifying the one or more nodes of the second set of nodes that is not present in the third graphical representation may include: (i) executing instructions for a graph comparison algorithm to obtain the difference, the difference indicating that a second information element (e.g., and, therefore a node) is not present in the third graphical representation, (ii) concluding, based on the difference, that the modification to the prompt (e.g., removal and/or replacement of the first information element) is related to the second information element being absent from the third graphical representation, and/or (iii) other methods.

Therefore, the first relationship may be established between: (i) removal of the first information element from the prompt and (ii) absence of the second information element in the second output.

Comparing the second information elements and the third information elements may also include identifying a third information element that is included in the third information elements (e.g., from the second output) that is not included in the second information elements (e.g., from the first output). Therefore, the third information element may have been generated by the generative AI model as a result of the removal and/or replacement of the first information element. Consequently, the first relationship may also indicate that appearance of the third information element may be related to the removal and/or replacement of the first information element.

At operation 318, the explainability report may be populated, based on the difference, with at least the first relationship. Populating the explainability report with at least the first relationship may include: (i) generating, using a second generative AI model, human-interpretable text summarizing the first relationship, (ii) adding the human-interpretable text summarizing the first relationship to the explainability report, (iii) adding one or more graphical representations (e.g., the first graphical representation, the second graphical representation, the third graphical representation) to the explainability report, and/or (iv) other methods.

The method may end following operation 318.

Thus, as illustrated above, embodiments disclosed herein may provide systems and methods usable to provide computer-implemented services using generative AI models. By providing an explainability report to a downstream consumer along with an output generated by the generative AI model in response to a prompt, a likelihood of the output meeting needs of the downstream consumer may be increased.

Turning to FIG. 3C, a third flow diagram illustrating a method of providing computer-implemented services using generative AI models in accordance with an embodiment is shown. The method may be performed, for example, by any of the components of the system of FIG. 1, and/or other components not shown therein. The method shown in FIG. 3C may provide a more computationally efficient method for generating explainability information for downstream consumers when compared to the method described in FIG. 3B.

At operation 320, an output generated by a generative artificial intelligence (AI) model based on a prompt may be obtained. Obtaining the output may include methods similar to those described with respect to operation 302 in FIG. 3A.

Prior to operation 322, a first graphical representation of the output may be obtained, and a GUI may be populated with the output and the first graphical representation. The GUI may be accessible by the downstream consumer. The first graphical representation may include: (i) nodes that correspond to information elements of the output, and (ii) edges that represent relationships between the nodes. Obtaining the first graphical representation may include: (i) executing a graph generation algorithm or feeding the information elements into an inference model to obtain the nodes and internal representations (e.g., descriptors) for the nodes, (ii) performing an analysis process, using the information elements and supplementary information, to obtain the edges (e.g., indicating patterns of data flows, data dependencies, workload performance for various entities), and/or (iii) other methods.

Populating the GUI with the first graphical representation may include: (i) uploading the first graphical representation (e.g., via an application programming interface) so that the first graphical representation is available to the user via the GUI, (ii) providing the first graphical representation to another entity responsible for uploading the first graphical representation to the GUI, and/or (iii) other methods.

After populating the GUI with the first graphical representation, preferences may be obtained from the downstream consumer that indicate a portion of the output that is desired to be viewed by the downstream consumer (e.g., filtering criteria, search terms). Obtaining the preferences may include: (i) receiving (e.g., via an application programming interface) a notification that the downstream consumer provided the preferences (e.g., via selecting one or more buttons on the GUI, via entering text into a text box on the GUI), (ii) reading the preferences from storage, the preferences being previously extracted from the GUI, and/or (iii) other methods.

A second graphical representation of the output may be generated based on the preferences. The second graphical representation of the output may include a subset of the nodes that correspond to the portion of the output to focus an attention of the downstream consumer on the subset of the nodes. For example, the first graphical representation may include a large number of nodes (e.g., may distract the downstream consumer, may be challenging for the downstream consumer to interpret, may include information that is not relevant to the needs of the downstream consumer). The feedback may be fed into a generative AI model (e.g., an LLM) to identify nodes relevant to the feedback. In addition, embedding similarity between each node of the first graphical representation and the feedback may be used to identify the nodes relevant to the feedback. Consequently, generating the second graphical representation may include methods similar to those described with respect to generating the first graphical representation. However, the nodes relevant to the feedback may be isolated (e.g., may be highlighted, other nodes may be grayed out, the second graphical representation of the output may only include the relevant nodes). Therefore, the downstream consumer may more easily obtain desired information content from the second graphical representation of the output than the first graphical representation of the output.

The GUI may be populated with the second graphical representation of the output. Populating the GUI with the second graphical representation of the output may include: uploading the second graphical representation (e.g., via an application programming interface) so that the second graphical representation is available to the downstream consumer via the GUI, (ii) providing the second graphical representation to another entity responsible for uploading the second graphical representation to the GUI, and/or (iii) other methods.

At operation 322, feedback may be obtained from a downstream consumer based on the output, the feedback indicating a desired modification to a portion of the output. Obtaining the feedback may include: (i) reading the feedback from storage, (ii) receiving the feedback (e.g., via a communication system, via a GUI) from another entity, and/or (iii) other methods. For example, the downstream consumer may utilize a chat interface (e.g., a chat window) of the GUI and may type the feedback into the chat interface.

At operation 324, a prompt optimization process may be performed using at least the prompt and the feedback to obtain one or more modified prompts. The one or more modified prompts may be usable as ingest for the generative AI model to generate modified outputs that meet: (i) the desired modification, and (ii) stability criteria for maintaining integrity of other portions of the output.

Performing the prompt optimization process may include: (i) iteratively perturbating information content of the prompt to obtain perturbated prompts, (ii) obtaining, using the perturbated prompts and the generative AI model, perturbated outputs, (iii) evaluating, using the output optimization algorithm, the perturbated outputs to obtain success scores for the perturbated outputs, and/or (iv) determining whether any of the success scores meet a success score threshold. If a subset of the success scores meet the success score threshold, performing the prompt optimization process may also include: (i) obtaining, using a subset of the perturbated outputs that correspond to the subset of the success scores, a subset of the perturbated prompts that were used to generate the subset of the perturbated outputs, (ii) using the subset of the perturbated prompts as the one or more modified prompts, and/or (iii) other methods. Refer to FIG. 3D for additional details regarding performing the prompt optimization process.

At operation 326, at least the one or more modified prompts may be provided to a downstream consumer as part of providing the computer-implemented services to the downstream consumer. Providing at least the one or more modified prompts may include methods similar to those described with respect to operation 306 in FIG. 3A.

The method may end following operation 326.

Turning to FIG. 3D, a fourth flow diagram illustrating a method of providing computer-implemented services using generative AI models in accordance with an embodiment is shown. The method may be performed, for example, by any of the components of the system of FIG. 1, and/or other components not shown therein. The method shown in FIG. 3D may be an expansion of operation 324 in FIG. 3C.

At operation 330, information content of the prompt may be iteratively perturbated to obtain perturbated prompts. Iteratively perturbating the information content of the prompt may include: (i) during a first perturbation of the information content of the prompt, removing a first information element of the information elements of the prompt to obtain a first modified prompt, (ii) during a second perturbation of the information content of the prompt, removing a second information element of the information elements of the prompt to obtain a second modified prompt, and/or (iii) other methods. Iteratively perturbating the information content of the prompt may include any number of perturbations to obtain any number of perturbated prompts.

Iteratively perturbating the information content of the prompt may also include: (i) replacing the first information element of the information elements of the prompt with a first replacement information element to obtain a third modified prompt, (ii) replacing the first information element of the information elements of the prompt with a second replacement information element to obtain a fourth modified prompt, and/or (iii) other methods.

For example, iteratively perturbating the information content of the prompt may include obtaining information elements of the prompt and/or other actions. Iteratively perturbating the information content of the prompt may also include performing at least one action selected from a list of actions consisting of: (i) removing a first information element of the information elements to obtain a first modified prompt, and (ii) replacing the first information element with a replacement information element to obtain the first modified prompt.

Refer to operation 310 of FIG. 3B for additional details regarding obtaining information elements, removing information elements from a prompt, and replacing information elements of a prompt with replacement information elements.

At operation 332, perturbated outputs may be obtained using the perturbated prompts and the generative AI model. Obtaining the perturbated outputs may include: (i) obtaining the perturbated prompts (e.g., the modified prompts), (ii) feeding each perturbated prompt of the perturbated prompts into the generative AI model to obtain the perturbated outputs, (iii) providing the perturbated prompts to another entity responsible for operating the generative AI model, and/or (iv) other methods.

At operation 334, the perturbated outputs may be evaluated using an objective function to obtain success scores for the perturbated outputs. Prior to evaluating the perturbated outputs using the objective function, the objective function may be obtained (e.g., read from storage, received from another entity, generated based on a defined objective and a set of constraints). Evaluating the perturbated outputs using the objective function may include: (i) calculating, using the perturbated outputs and the objective function, the success scores (e.g., using an algorithm, model, or other means of performing calculations using the objective function), (ii) providing the perturbated outputs and the objective function to another entity responsible for calculating the success scores, and/or (iii) other methods.

At operation 336, it may be determined whether any of the success scores meet a success score threshold. The success score threshold may be obtained via: (i) reading the success score threshold from storage, (ii) receiving the success score threshold from another entity (e.g., a downstream consumer, a subject matter expert), and/or (iii) other methods.

Determining whether any of the success scores meet the success score threshold may include: (i) comparing quantifications included in the success scores to a quantification included in the success score threshold, (ii) providing the success scores and the success score threshold to another entity responsible for comparing the success scores to the success score threshold, and/or (iii) other methods. For example, if the success scores are assigned using a scale of 1-10 with 1 being the lowest success score and 10 being the highest success score, a numerical quantity (e.g., a number between 1-10) may be obtained for each modified output. The numerical quantity for each modified output may be compared to a numerical quantity (e.g., at least 8) associated with the success score threshold.

If one or more of the success scores meets the success score threshold, the method may proceed to operation 338. If none of the success scores meet the success score threshold, the method may return to operation 330. If the method returns to operation 330, additional iterative modifications may be performed for the prompt followed by testing processes for the modified prompts (e.g., refer to FIG. 2C for additional details regarding the looping process for performing iterative modifications to the prompt in an attempt to achieve a goal such as minimizing the objective function).

At operation 338, a subset of the perturbated prompts that were used to generate a subset of the perturbated outputs may be obtained using the subset of the perturbated outputs that correspond to the subset of the success scores. Obtaining the subset of the perturbated prompts may include: (i) reading the subset of the perturbated prompts from storage, (ii) receiving the subset of the perturbated prompts from another entity (e.g., via a communication system), (iii) performing a search process using search terms to identify relevant perturbated prompts from a database or other data storage architecture, and/or (iv) other methods.

At operation 340, the subset of the perturbated prompts may be used as the one or more modified prompts. Using the subset of the perturbated prompts as the one or more modified prompts may include: (i) generating a log entry in an event log indicating that the subset of the perturbated prompts is to be provided to the downstream consumer as the one or more modified prompts, (ii) notifying another entity (e.g., the downstream consumer, a third party) that the subset of the perturbated prompts is to be used as the one or more modified prompts, and/or (iii) other methods.

The method may end following operation 340.

Thus, as illustrated above, embodiments disclosed herein may provide systems and methods usable to provide computer-implemented services using generative AI models. By obtaining one or more modified prompts using an optimization algorithm to meet needs of a downstream consumer while maintaining stability of portions of the output, a likelihood of the computer-implemented services meeting needs of the downstream consumer may be increased.

Any of the components illustrated in FIGS. 1-2H may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for providing computer-implemented services using generative artificial intelligence (AI) models, the method comprising:
obtaining an output generated by a generative AI model of the generative AI models based on a prompt;
obtaining, based on the output, feedback from a downstream consumer, the feedback indicating a desired modification to a portion of the output;
performing, using at least the prompt and the feedback, a prompt optimization process to obtain one or more modified prompts that are usable as ingest for the generative AI model to generate modified outputs that meet:
the desired modification, and
stability criteria for maintaining integrity of other portions of the output; and
providing at least the one or more modified prompts to a downstream consumer as part of providing computer-implemented services to the downstream consumer.

2. The method of claim 1, wherein the desired modification comprises at least one modification selected from a list of modifications consisting of:
removal of information content of the portion of the output; and
replacement of the information content of the portion of the output with other information content.

3. The method of claim 1, wherein performing the prompt optimization process comprises:
iteratively perturbating information content of the prompt to obtain perturbated prompts;
obtaining, using the perturbated prompts and the generative AI model, perturbated outputs;
evaluating, using an objective function, the perturbated outputs to obtain success scores for the perturbated outputs;
making a determination, using a success score threshold and the success scores, regarding whether any of the success scores meet the success score threshold;
in an instance of the determination in which a subset of the success scores meets the success score threshold:
obtaining, using a subset of the perturbated outputs corresponding to the subset of the success scores, a subset of the perturbated prompts that were used to generate the subset of the perturbated outputs; and
using the subset of the perturbated prompts as the one or more modified prompts.

4. The method of claim 3, wherein iteratively perturbating the information content of the prompt comprises:
obtaining information elements of the prompt; and
performing at least one action selected from a list of actions consisting of:
removing a first information element of the information elements to obtain a first modified prompt; and
replacing the first information element with a replacement information element to obtain the first modified prompt.

5. The method of claim 4, wherein the objective function assigns the success scores to the perturbated outputs based on:
degrees to which the perturbated outputs meet the desired modification; and
degrees to which the perturbated outputs meet the stability criteria.

6. The method of claim 5, wherein the stability criteria define at least a maximum acceptable difference between information elements of the output and information elements of a modified output of the modified outputs.

7. The method of claim 3, wherein the prompt optimization process is performed, at least in part, using an optimization algorithm to guide the iterative perturbating of the information content of the prompt to obtain the perturbated prompts.

8. The method of claim 7, wherein the optimization algorithm is a bacterial foraging optimization (BFO) algorithm.

9. The method of claim 1, further comprising:
prior to obtaining the feedback from the downstream consumer:
obtaining a first graphical representation of the output, the first graphical representation comprising:
nodes that correspond to information elements of the output, and
edges that represent relationships between the nodes; and
populating a graphical user interface (GUI) with the output and the first graphical representation, the GUI being accessible by the downstream consumer.

10. The method of claim 9, further comprising:
after populating the GUI with the output and the first graphical representation:
obtaining, from the downstream consumer and via the GUI, preferences that indicate a portion of the output that is desired to be viewed by the downstream consumer;
generating, based on the preferences, a second graphical representation of the output, the second graphical representation comprising a subset of the nodes that correspond to the portion of the output to focus an attention of the downstream consumer on the subset of the nodes; and
populating the GUI with the second graphical representation.

11. The method of claim 1, wherein the generative AI model is a large language model (LLM).

12. A non-transitory machine-readable medium having instructions stored therein, which when executed by a processor, cause the processor to perform operations for providing computer-implemented services using generative artificial intelligence (AI) models, the operations comprising:
obtaining an output generated by a generative AI model of the generative AI models based on a prompt;
obtaining, based on the output, feedback from a downstream consumer, the feedback indicating a desired modification to a portion of the output;
performing, using at least the prompt and the feedback, a prompt optimization process to obtain one or more modified prompts that are usable as ingest for the generative AI model to generate modified outputs that meet:
the desired modification, and
stability criteria for maintaining integrity of other portions of the output; and
providing at least the one or more modified prompts to a downstream consumer as part of providing computer-implemented services to the downstream consumer.

13. The non-transitory machine-readable medium of claim 12, wherein the desired modification comprises at least one modification selected from a list of modifications consisting of:
removal of information content of the portion of the output; and
replacement of the information content of the portion of the output with other information content.

14. The non-transitory machine-readable medium of claim 12, wherein performing the prompt optimization process comprises:
iteratively perturbating information content of the prompt to obtain perturbated prompts;
obtaining, using the perturbated prompts and the generative AI model, perturbated outputs;
evaluating, using an objective function, the perturbated outputs to obtain success scores for the perturbated outputs;
making a determination, using a success score threshold and the success scores, regarding whether any of the success scores meet the success score threshold;
in an instance of the determination in which a subset of the success scores meets the success score threshold:
obtaining, using a subset of the perturbated outputs corresponding to the subset of the success scores, a subset of the perturbated prompts that were used to generate the subset of the perturbated outputs; and
using the subset of the perturbated prompts as the one or more modified prompts.

15. The non-transitory machine-readable medium of claim 14, wherein iteratively perturbating the information content of the prompt comprises:
obtaining information elements of the prompt; and
performing at least one action selected from a list of actions consisting of:
removing a first information element of the information elements to obtain a first modified prompt; and
replacing the first information element with a replacement information element to obtain the first modified prompt.

16. The non-transitory machine-readable medium of claim 15, wherein the objective function assigns the success scores to the perturbated outputs based on:
degrees to which the perturbated outputs meet the desired modification; and
degrees to which the perturbated outputs meet the stability criteria.

17. A data processing system, comprising:
a processor; and
a memory coupled to the processor to store instructions, which when executed by the processor, cause the processor to perform operations for providing computer-implemented services using generative artificial intelligence (AI) models, the operations comprising:
obtaining an output generated by a generative AI model of the generative AI models based on a prompt;
obtaining, based on the output, feedback from a downstream consumer, the feedback indicating a desired modification to a portion of the output;
performing, using at least the prompt and the feedback, a prompt optimization process to obtain one or more modified prompts that are usable as ingest for the generative AI model to generate modified outputs that meet:
the desired modification, and
stability criteria for maintaining integrity of other portions of the output; and
providing at least the one or more modified prompts to a downstream consumer as part of providing computer-implemented services to the downstream consumer.

18. The data processing system of claim 17, wherein the desired modification comprises at least one modification selected from a list of modifications consisting of:
removal of information content of the portion of the output; and
replacement of the information content of the portion of the output with other information content.

19. The data processing system of claim 17, wherein performing the prompt optimization process comprises:
iteratively perturbating information content of the prompt to obtain perturbated prompts;
obtaining, using the perturbated prompts and the generative AI model, perturbated outputs;
evaluating, using an objective function, the perturbated outputs to obtain success scores for the perturbated outputs;
making a determination, using a success score threshold and the success scores, regarding whether any of the success scores meet the success score threshold;
in an instance of the determination in which a subset of the success scores meets the success score threshold:
obtaining, using a subset of the perturbated outputs corresponding to the subset of the success scores, a subset of the perturbated prompts that were used to generate the subset of the perturbated outputs; and
using the subset of the perturbated prompts as the one or more modified prompts.

20. The data processing system of claim 19, wherein iteratively perturbating the information content of the prompt comprises:
obtaining information elements of the prompt; and
performing at least one action selected from a list of actions consisting of:
removing a first information element of the information elements to obtain a first modified prompt; and
replacing the first information element with a replacement information element to obtain the first modified prompt.
